(19) United States
(12) Patent Application Publication
(10) Pub. No.: US 2025/0187139 A1
(43) Pub. Date: Jun. 12, 2025

(54) Needle Grinder

(71) Applicant: Royal Master Grinders, Inc., Oakland, NJ (US)

(72) Inventors: John R. Memmelaar, JR., Midland Park, NJ (US); Todd R. Morris, New Windsor, NY (US)

(73) Assignee: Royal Master Grinders, Inc., Oakland, NJ (US)

(21) Appl. No.: 18/968,494

(22) Filed: Dec. 4, 2024

Related U.S. Application Data
(60) Provisional application No. 63/608,398, filed on Dec. 11, 2023.

(51) Int. Cl. B24B 41/00; B24B 19/16; B24B 41/06

(52) U.S. Cl. CPC B24B 41/005; B24B 19/16; B24B 41/066

(57) ABSTRACT

Disclosed herein is a fixture for a workpiece, a system, and a method for performing a machining operation using the fixture. The fixture may include a plurality of holders coupled to a frame. Each holder may be configured to receive and secure a workpiece and may be rotationally coupled to the frame. An actuator may be operatively coupled to the plurality of holders to drive rotation of the holders with respect to the frame. A linear actuator may be configured to linearly translate the plurality of holders. A coupler may be configured to couple the fixture to a manipulator. The manipulator may be configured to move the fixture. The fixture may be configured to rotate a plurality of workpieces by the actuator and simultaneously linearly translate the plurality of workpieces by the linear actuator.

### CROSS-REFERENCE TO RELATED APPLICATIONS

This application claims the benefit of the filing date of U.S. Provisional Patent Application No. 63/608,398 filed Dec. 11, 2023, the disclosure of which is hereby incorporated herein by reference.

### FIELD OF THE INVENTION

The present invention relates generally to a fixture for a workpiece and a system for performing a machining operation, and in particular relates to a fixture with a linear translator for holding and manipulating a workpiece and a system for performing a machining operation using the fixture.

### BACKGROUND OF THE INVENTION

Cannulas can be manufactured through a process of grinding hollow tubes against a grinding surface. This can be accomplished by loading the cannulas into a cartridge or fixture and positioning them against a grinding surface. The cannulas may be rotated one or more times during the grinding process in order to achieve a desired point style, such as the Menghini needle which is created by turning the cannula clockwise and counterclockwise, and also linearly translating it in a backward and forward motion during the machining process to generate the beveled finish. Grinding can be carried out with a variety of different methods, such as with electrochemical grinding. This grinding process typically requires multiple steps and is often performed in a series of stages which requires changing out different parts of the grinding system, thus making the manufacturing expensive and slow.

In addition to the grinding operation, various other operations are required to complete the manufacture of a cannula. For example, various pre-processing operations are needed to prepare the cannula for grinding, and various post-processing operations are required to prepare the cannula for use after grinding. During these various operations, the cannula or cannulas must be moved from one workstation to another, securely held in place, and moved and rotated in each workstation to complete the processing step at each workstation.

Thus, an improved cannula manufacturing system and method is desired.

### BRIEF SUMMARY OF THE INVENTION

In certain embodiments, the present disclosure relates generally to a fixture for holding a workpiece with a rotary actuator to rotate the workpiece and a linear actuator to translate the workpiece. In other embodiments, the present disclosure relates to a system for performing a machining operation using the fixture. In still other embodiments, the present disclosure relates to a method for performing a machining operation using the fixture.

In accordance with an aspect of the present disclosure, a fixture for holding a plurality of workpieces is provided. A fixture according to this aspect, may include a plurality of holders coupled to a frame, each holder configured to receive and secure a workpiece, each holder being rotationally coupled to the frame, an actuator operatively coupled to the plurality of holders to drive rotation of the holders with respect to the frame, a linear actuator configured to linearly translate the plurality of holders, and a coupler configured to couple the fixture to a manipulator. The manipulator may be configured to move the fixture. The fixture may be configured to rotate a plurality of workpieces by the actuator and simultaneously linearly translate the plurality of workpieces by the linear actuator.

Continuing in accordance with this aspect, each of the holders may be coupled to a respective holder gear. The actuator may include a shaft having a shaft gear. The shaft gear may be operatively coupled to the holder gears to drive rotation of the holders with respect to the frame.

Continuing in accordance with this aspect, the linear actuator may include an electric rod actuator for translating the plurality of holders. The linear actuator may include a ball spline.

Continuing in accordance with this aspect, the endcap may be fixed to a rod of the linear actuator. The endcap may be configured to connect the linear actuator to the frame.

Continuing in accordance with this aspect, the linear actuator may be enclosed by a cover plate and a case.

Continuing in accordance with this aspect, at least one of the plurality of workpiece may include a needle.

Continuing in accordance with this aspect, the plurality of holders may include a plurality of collets. Each of the plurality of collets may be configured to releasably secure a workpiece.

Continuing in accordance with this aspect, the manipulator may be a robot. The robot may include a robot arm having a distal end including a rotational actuator. The fixture may be configured to be coupled to the distal end of the robot arm such that the actuator of the fixture may be operatively coupled to the rotational actuator of the robot.

In accordance with another aspect of the present disclosure, a grinding system is provided. A grinding system according to this aspect, may include a grinding surface, an end effector including a frame with a plurality of holders and a plurality of workpieces, each holder configured to receive and secure a workpiece, each holder being rotationally coupled to the frame, a first actuator operatively coupled to the plurality of holders to drive rotation of the holders with respect to the frame, a second actuator operatively coupled to the plurality of holders to linearly translate the holders, and a coupler configured to couple the end effector to a manipulator. The manipulator may be configured to rotate, move, and position the end effector with respect to the grinding surface such that the workpieces may contact the grinding surface to grind the workpieces in a first position of the end effector, and may not contact the grinding surface in a second position of the end effector. A rotation of the first actuator may cause each of the plurality of workpieces to simultaneously rotate about each workpiece axis and a linear translation of the second actuator may cause each of the plurality of workpieces to simultaneously move along each workpiece axis.

Continuing in accordance with this aspect, each of the holders may be coupled to a respective holder gear. The first actuator may include a shaft having a shaft gear. The shaft gear may be operatively coupled to the holder gears to drive rotation of the holders with respect to the frame.

Continuing in accordance with this aspect, the second actuator may include an electric rod actuator for translating the plurality of holders. The second actuator may include a ball spline.

Continuing in accordance with this aspect, the grinding system may include an endcap fixed to a rod of the second actuator. The endcap may be configured to connect the second actuator to the frame.

Continuing in accordance with this aspect, the second actuator may be enclosed by a cover plate and a case.

Continuing in accordance with this aspect, the workpiece may include a needle.

Continuing in accordance with this aspect, the plurality of holders may include a plurality of collets. Each of the plurality of collets may be configured to releasably secure a workpiece.

Continuing in accordance with this aspect, the manipulator may be a robot. The robot may include a robot arm having a distal end including a rotational actuator. The second actuator may be configured to be coupled to the distal end of the arm such that the second actuator may be operatively coupled to the rotational actuator of the robot.

In accordance with another aspect of the present disclosure, a method for grinding a workpiece is provided. A method according to this aspect, may include the steps of contacting a workpiece to a grinding wheel by moving a fixture holding the workpiece using a manipulator to form a first facet at a distal end of the workpiece, rotating the workpiece by a first actuator of the fixture, and linearly translating the workpiece by a second actuator of the fixture to generate a second facet at the distal end of the workpiece.

Continuing in accordance with this aspect, the workpiece may be defined by a hollow cylindrical body. The workpiece may be a needle. The needle may be a Menghini needle.

Continuing in accordance with this aspect, the first facet may be inclined to a longitudinal axis of the workpiece. The second facet may be a bevel. The bevel may extend around the distal end of the workpiece. The bevel may include a cutting edge.

In accordance with another aspect, a method for grinding a plurality of workpieces is provided. A method according to this aspect, may include the steps of contacting a plurality of workpieces to a grinding wheel by moving a fixture holding the plurality of workpieces using a manipulator to form a first facet at a distal end of each workpiece, rotating each workpiece about a longitudinal axis of each workpiece by a first actuator of the fixture, and linearly translating each workpiece along the longitudinal axis of each workpiece by a second actuator of the fixture to generate a second facet at the distal end of each workpiece.

Continuing in accordance with this aspect, at least one workpiece may be defined by a hollow cylindrical body. The at least one workpiece may be a needle. The needle may be a Menghini needle. The first facet of the Menghini needle may be inclined to the longitudinal axis of the Menghini needle. The second facet may be a bevel. The bevel may extend around the distal end of the Menghini needle. The bevel may include a cutting edge.

### BRIEF DESCRIPTION OF THE DRAWINGS

A more complete appreciation of the subject matter of the present disclosure and the various advantages thereof may be realized by reference to the following detailed description, in which reference is made to the following accompanying drawings:

FIG. 1 is a perspective view of a fixture and a manipulator according to an embodiment of the present disclosure;

FIG. 2 is a perspective view of a linear actuator of the fixture of FIG. 1;

FIG. 3 is another perspective view of the linear actuator of FIG. 2;

FIG. 4 is a perspective view of a cover of the linear actuator of FIG. 2;

FIG. 5 is an exploded perspective view of the linear actuator of FIG. 2;

FIG. 6 is a perspective cross-sectional view of the linear actuator of FIG. 2;

FIG. 7 is fixture and a manipulator according to another embodiment of the present disclosure;

FIG. 8 is a side view showing a distal end of a workpiece;

FIG. 9 is a front perspective view of a fixture with a rotary actuator according to an embodiment of the present disclosure;

FIG. 10 is a back perspective view of the fixture of FIG. 9;

FIG. 11 is a front perspective view of the rotary actuator of FIG. 9;

FIG. 12 is a perspective view of a grinding system according to another embodiment of the present disclosure, and

FIG. 13 is a schematic view of a machining system according to another embodiment of the present disclosure.

### DETAILED DESCRIPTION

Reference will now be made in detail to the various embodiments of the present disclosure illustrated in the accompanying drawings. Wherever possible, the same or like reference numbers will be used throughout the drawings to refer to the same or like features. It should be noted that the drawings are in simplified form and are not drawn to precise scale. Additionally, the term “a,” as used in the specification, means “at least one”.

As used herein, the terms “cannula,” “needle” and “workpiece” will be used interchangeably and as such, unless otherwise stated, the explicit use of any terms is inclusive of the other term. Similarly, the terms “fixture,” “end effector,” and “robotic end effector” will be used interchangeably and as such, unless otherwise stated, the explicit use of any of these terms is inclusive of the other term.

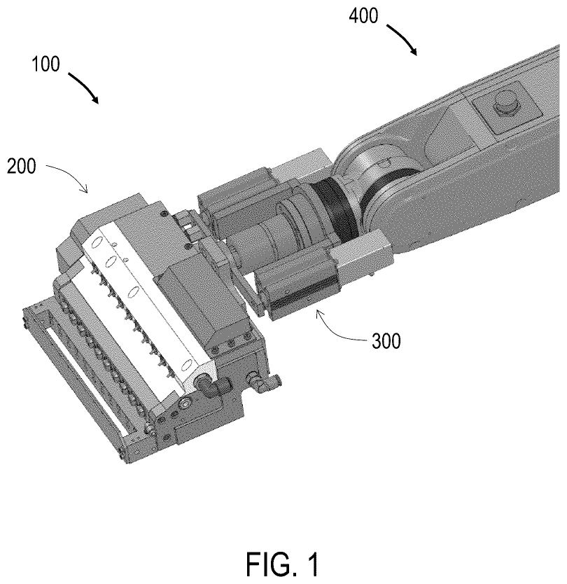

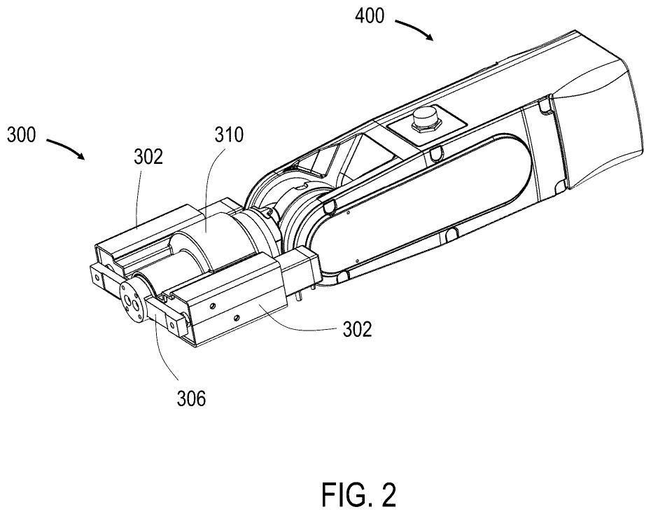

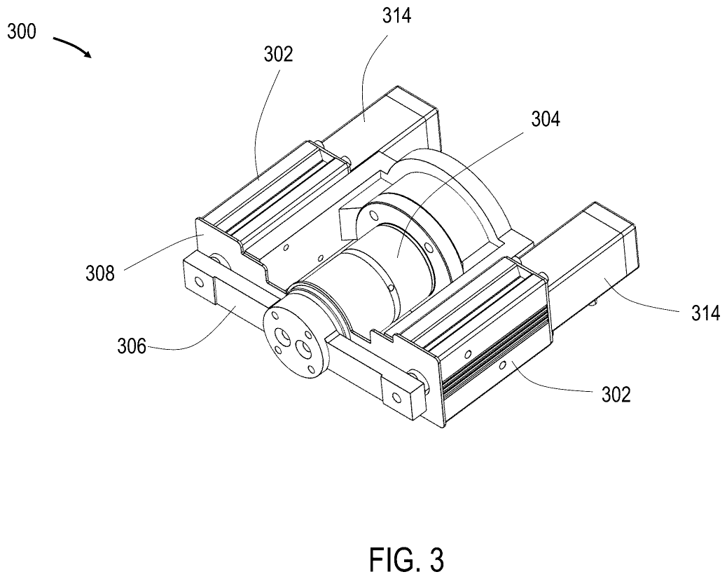

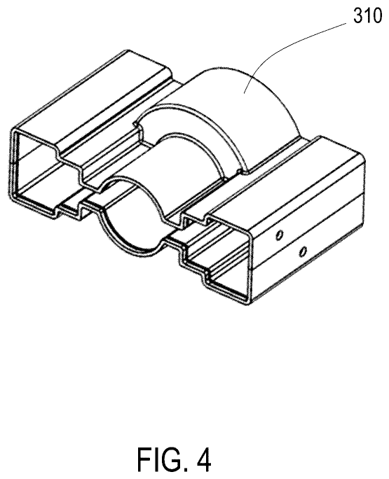

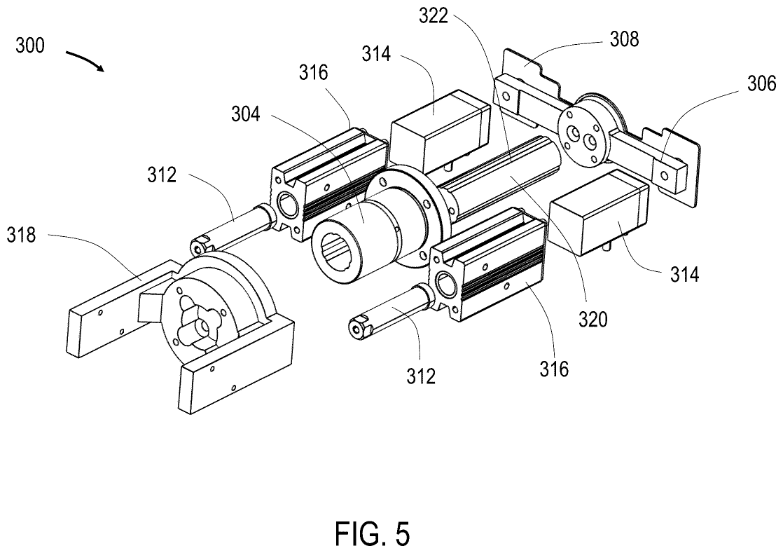

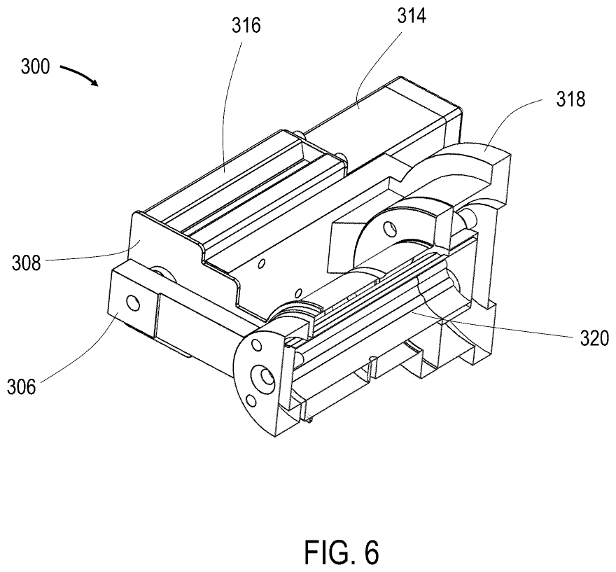

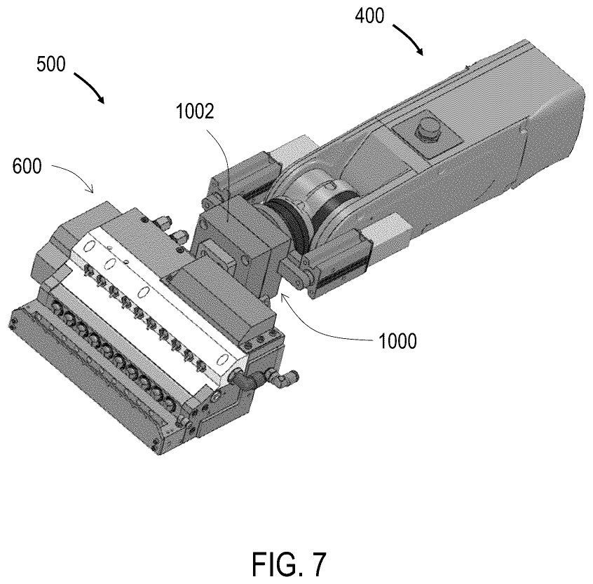

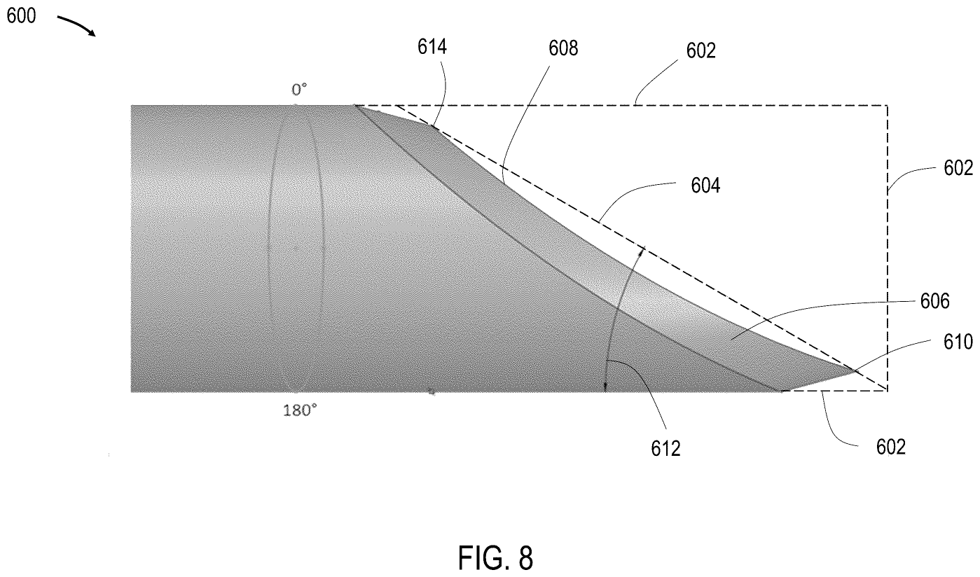

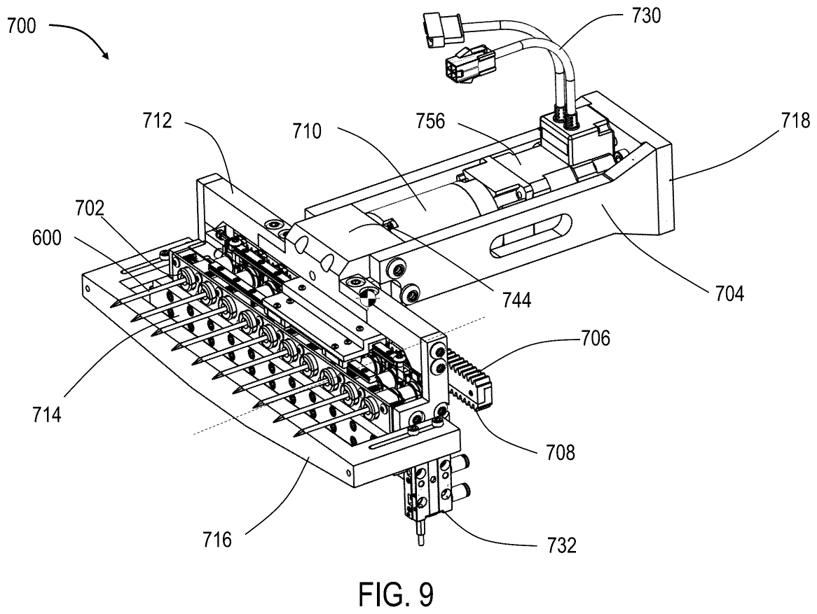

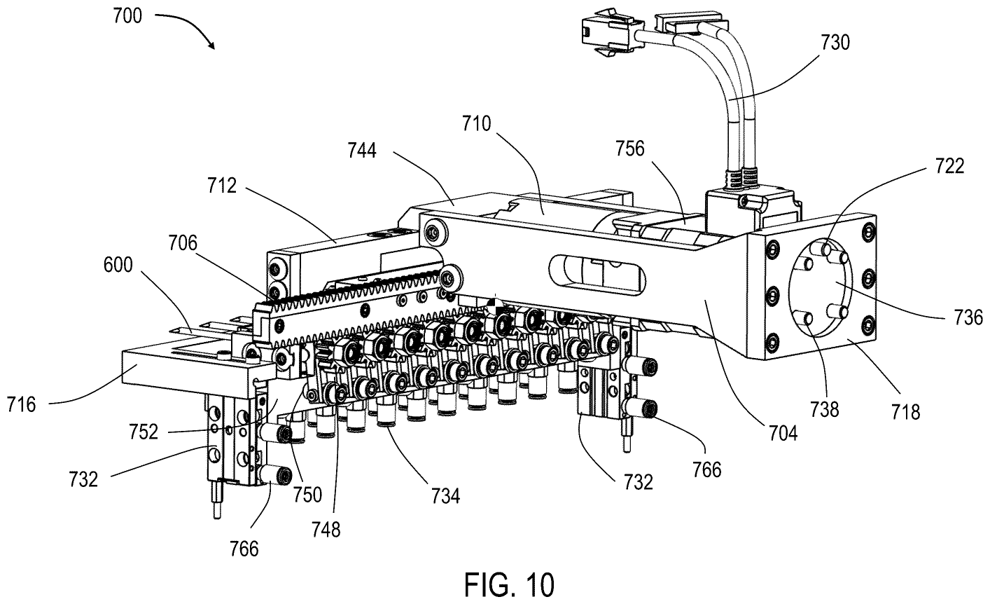

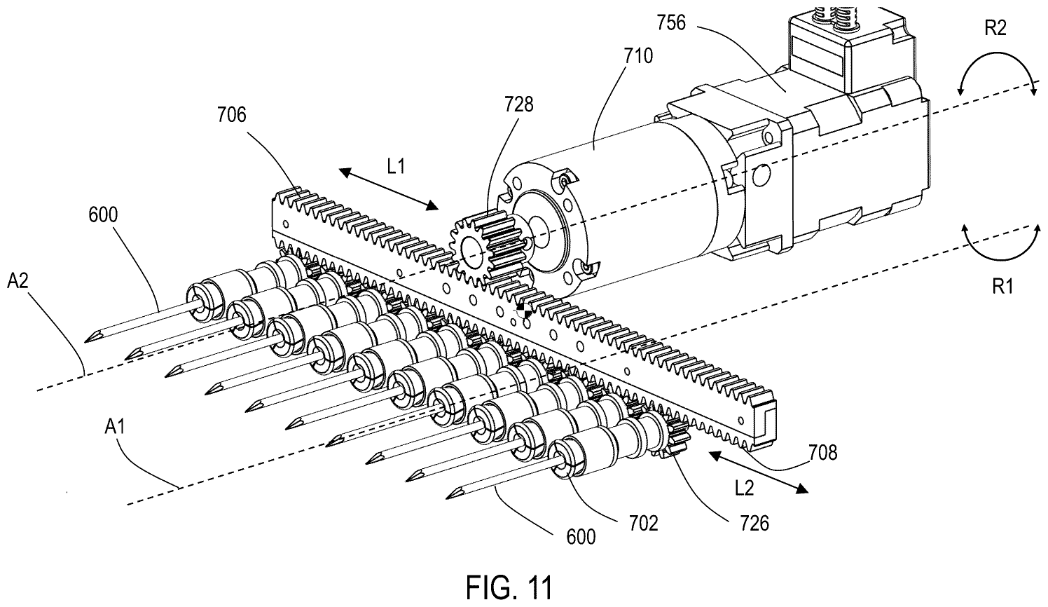

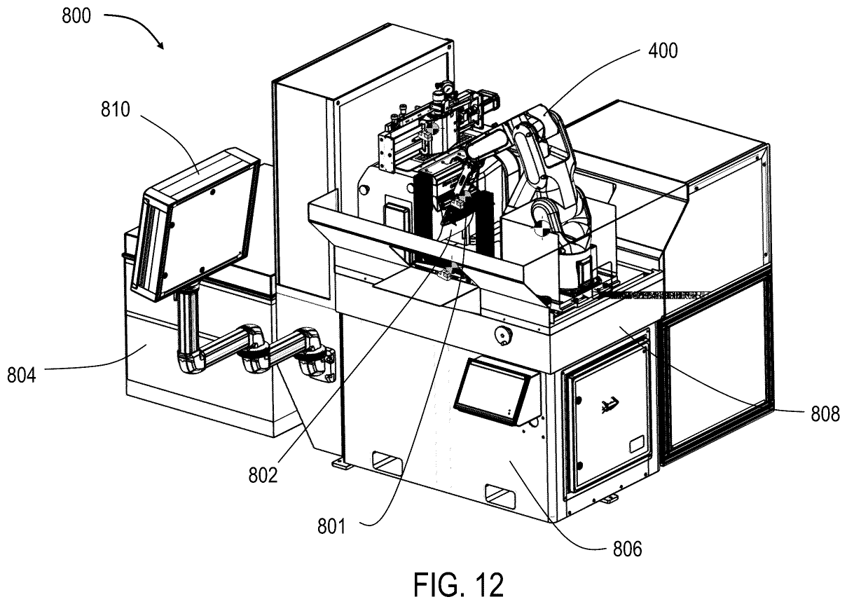

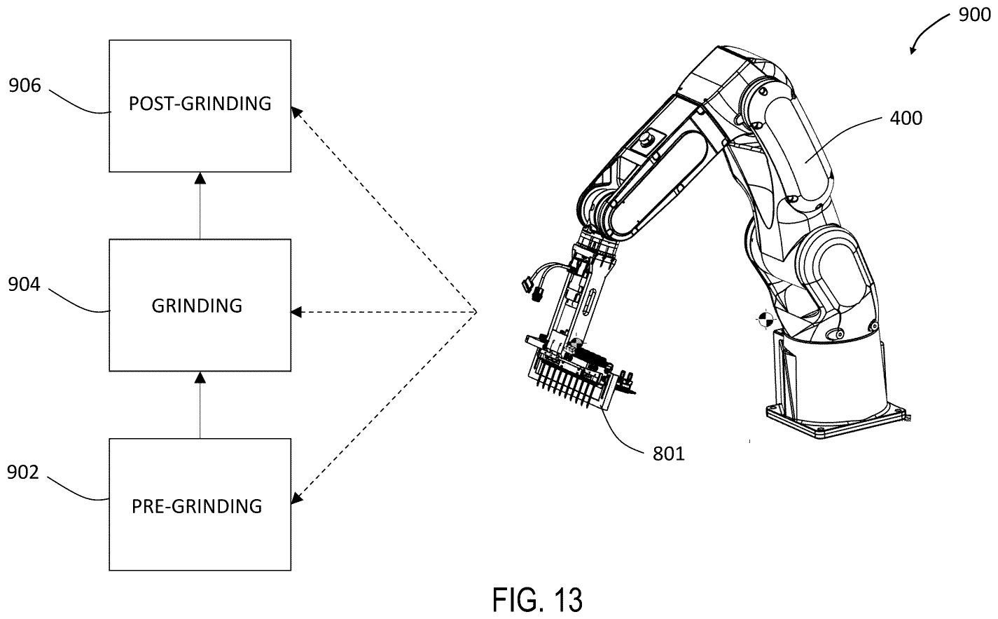

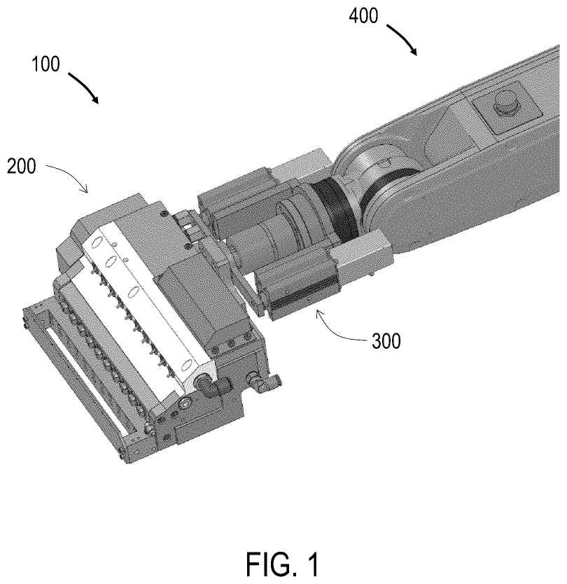

FIG. 1 is a perspective view of a fixture 100 according to an embodiment of the present disclosure. Fixture 100 includes a rotary actuator 200 and a linear actuator 300 for simultaneous movement and precise positioning of multiple workpieces in order to impart the desired shape to the workpieces. Both actuators are coupled together for rotation and linear translation relative to a grinding wheel which then enables the grinding of the workpieces in accordance with desired specifications. A linking structure or coupler installed on fixture 100 enables a manipulator 400 such as a robot to move and position the fixture as required for the machining operation goal. Rotary actuator 200 can provide multi-axis rotary movement capability. This enables the simultaneous rotation of workpieces about one or more axes while in contact with the grinding wheel, which in-turn provides the desired shape to the workpiece by imparting the material from the edges of the workpiece. Linear actuator 300 facilitates the linear transition of the workpiece with reference to the grinding wheel to provide extra features and shaping as desired by the user. Both these actuators in support with the manipulator 400 provide the fixtures movement which is needed to precisely carry out grinding of the workpieces. Thus, the simultaneous coordination of these components—the rotary actuator, the linear actuator, as well as the manipulator-gives the desired motion and accuracy of fixture 100, quickly and precisely completing the machining process.

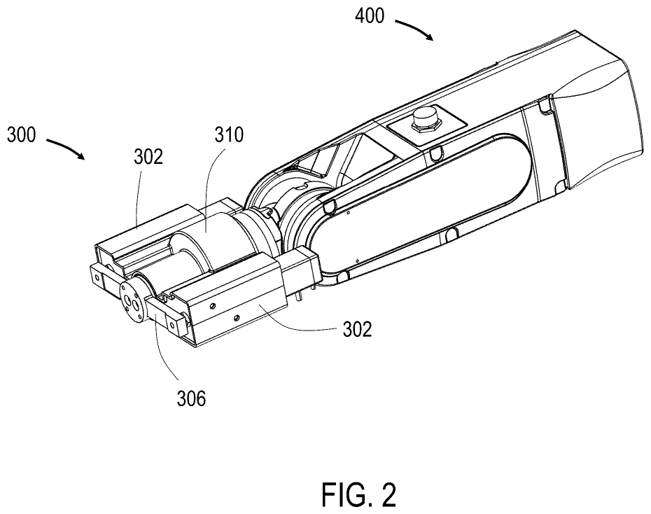

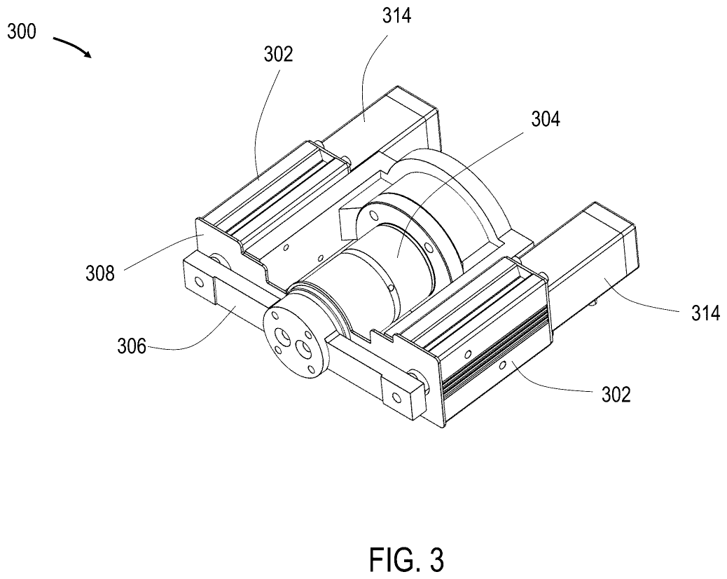

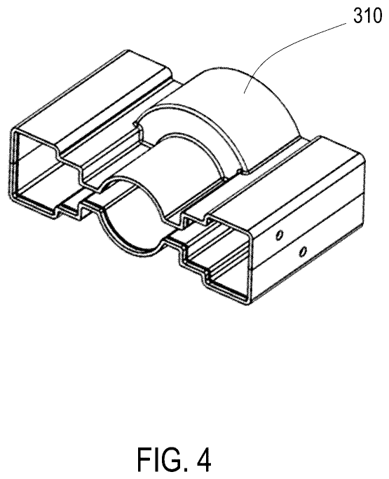

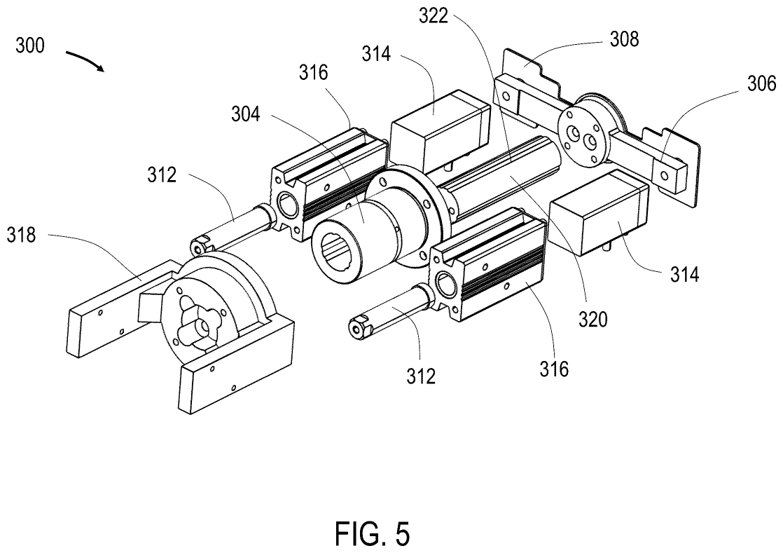

FIGS. 2-6 show various details of linear actuator 300 according to an embodiment of the present disclosure. A pair of electric rod actuators 302 are located between a ball spline 304 and as shown in FIG. 2. A cover plate 308 is provided on one end of linear actuator 300. Attached to cover plate 308 is an endcap 306 to allow attachment to rotary actuator 200. Electric rod actuators 302 are connected to ball spline 304 in the middle and housed within a case 310 as shown in FIG. 4. The ball spline provides a connection between the electric rod actuators allowing them to move forward and backward in a linear direction. Electric rod actuators 302 are the source of power for linear actuator 300, converting electrical energy into linear motion. When electricity is supplied to them, they rotate and translate linear motion to ball spline 304, which slides on rods 312, moving in a linear direction as best shown in FIG. 5.

Each electric rod actuator 302 includes a motor 314, rod 312 and body 316 as shown in FIG. 5. Motor 314 is connected directly to rod 312 so that when motor 314 is activated rod 312 is moved in or out of body 316. Body 316 is designed to guide or restrain the motion of rod 312 to ensure precise and backlash free linear motion along a specified path. Rod 312 can include a nut (not shown) on either end that locks into a groove in body 316 to guarantee that the provided motion is correctly controlled. Motors 314 can be powered by an electrical control panel or power supply. When the power supply sends a signal to motor 314, it causes rod 312 to move either in or out of the body 316. For example, motor 314 can rotate in one direction to move the rod 312 in and then rotate in the opposite direction to move it out. The speed of the rod motion can be controlled by the power supply. Rod 312 can also be equipped with sensors that detect the current position of the rod 312. While linear actuator 300 includes an electric rod actuator 302 in this embodiment, various other type of actuators such as a pneumatic actuator, hydraulic actuator, voice coil actuator, etc. can be used in other embodiments.

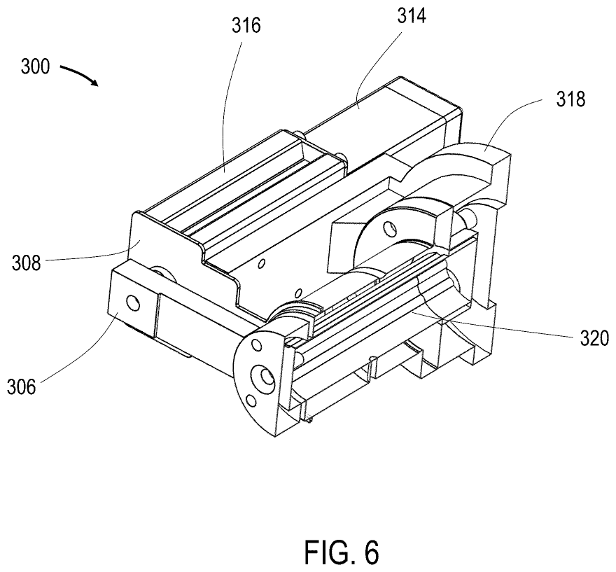

Ball spline 304 includes a shaft 320 with a series of balls placed in grooves 322 on the shaft as best shown in FIGS. 5 and 6. The grooves and balls are configured to allow for rotational motion and axial movement of shaft 320, while still giving it linear support. The balls are secured in grooves 322 by a nut housing and held in place by a series of ball bearings contained in the nut. This forms a flexible joint that efficiently transfers linear motion. Ball spline 304 allows for a significant amount of load to be transferred while still maintaining a high degree of accuracy as the balls are able to move freely in grooves 322, when shaft 320 moves. Grooves 322 can be provided with a specific pitch and spacing. Thus, as rods 312 turn ball spline 304, the balls travel through grooves 322 and roll, pushing shaft 320 in a linear movement.

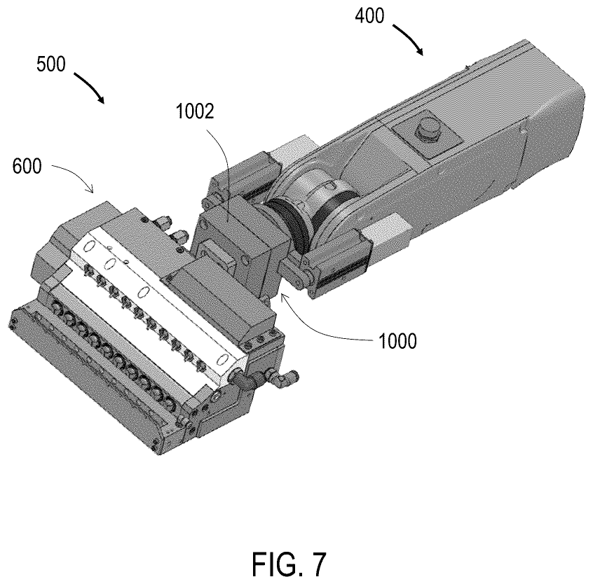

While two electric rod actuators 302 are disclosed in this embodiment, other embodiments can have a single electric rod actuator or a plurality of electric rod actuators. It should be understood that the position and number of ball spline with respect to the electric rod actuators can be varied in other embodiments. For example, the linear actuator can include a single electric rod actuator with two ball splines located on each side of the electric rod actuator. While a ball spline is shown in this embodiment, other linear motion bearings such as a lead screw, ball chain, rack and pinion, belt drive, etc., can be used in other embodiments. An example of a fixture 500 including a linear actuator 1000 with an electric rod actuator directly connected to rotary actuator 200 via a rigid joint 1002, such as a male-female spline connection, according to another embodiment of the present disclosure is shown in FIG. 7.

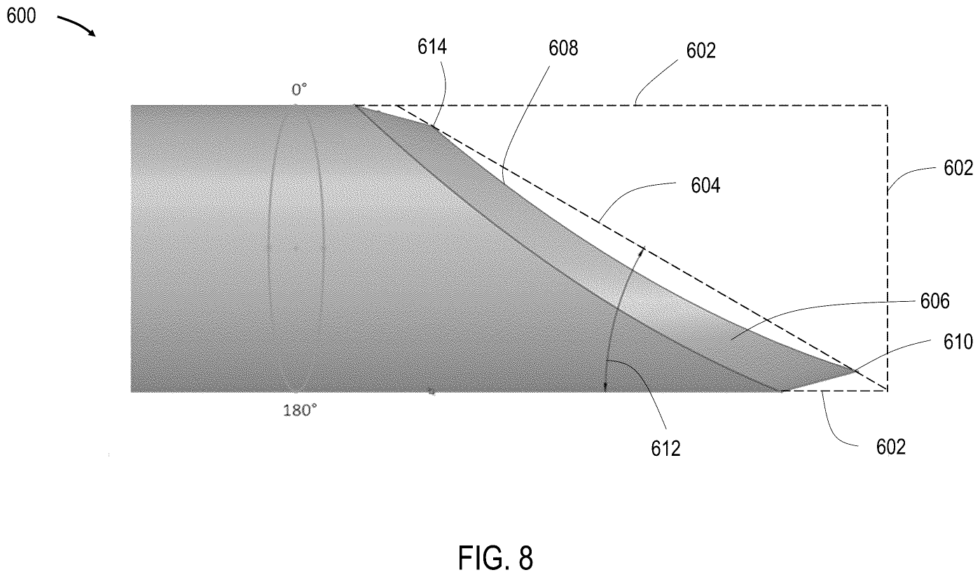

Referring now to FIG. 8, there is shown a distal end of a workpiece such as a Menghini needle 600. Menghini needle 600 is used in biopsies and features a hollow metal cylinder with cutting edges 608 such as side-firing cutting edges at the distal end and a blunt, curved tip at a leading edge 610 and heel 614. Cutting edges 608 defined the distal end of a bevel 606 formed around the distal end of Menghini needle 600. This geometry is important in order to effectively access and sample tissue. The curved blunt end of leading edge 610 helps to reduce the risk of damaging adjacent anatomy. The side-firing cutting edges 608 allow the needle to be rotated and the tip advanced through tissue in order to sample from multiple angles. This ensures that multiple cores of tissue can be obtained for analysis.

Fixtures 100 and 500 disclosed herein can receive and secure multiple workpieces for a grinding process to impart the distal end profile of the Menghini needle as more fully described below. Rotary actuator 200 provides multi-axis rotary movement capability, enabling simultaneous rotation of multiple Menghini needles around one or more axes to achieve the desired shape by removing material from its edges. Linear actuator 300 facilitates linear transition of the needle with respect to the grinding wheel, enabling extra shaping and features. Linear actuator 300 and rotary actuator 200 can both be operated using individual precision motors, such as servo motors, to separately and accurately regulate the movements of linear and rotary translation respectively. This provides a reliable system to accurately monitor and control the movement of the two actuators, enabling precise grinding. The manipulator 400 acts in support of the rotary and linear actuators, providing the fixture movement necessary to execute grinding with precision. The coordinated motion of these components accurately and quickly completes the machining process of Menghini needle 600. Linear actuator 300 and rotary actuator 200 can be controlled by individual precision motors such as servo motors to individually track and control linear translation and rotatory translation.

For example, one or more hollow cylindrical workpieces 600 defining an initial profile as shown by line 602 are secured to fixture 100 in a first step. A first grinding process is performed by the manipulator which positions fixture 100 against a grinding wheel to impart a first facet 604 to each workpiece 600. A tip angle 612 shown in FIG. 8 indicates the angle at which the multiple workpieces are presented to the grinding wheel to generate first facet 604 using the manipulator 400. No movement from rotary actuator 200 or linear actuator 300 is necessary if the first grinding process.

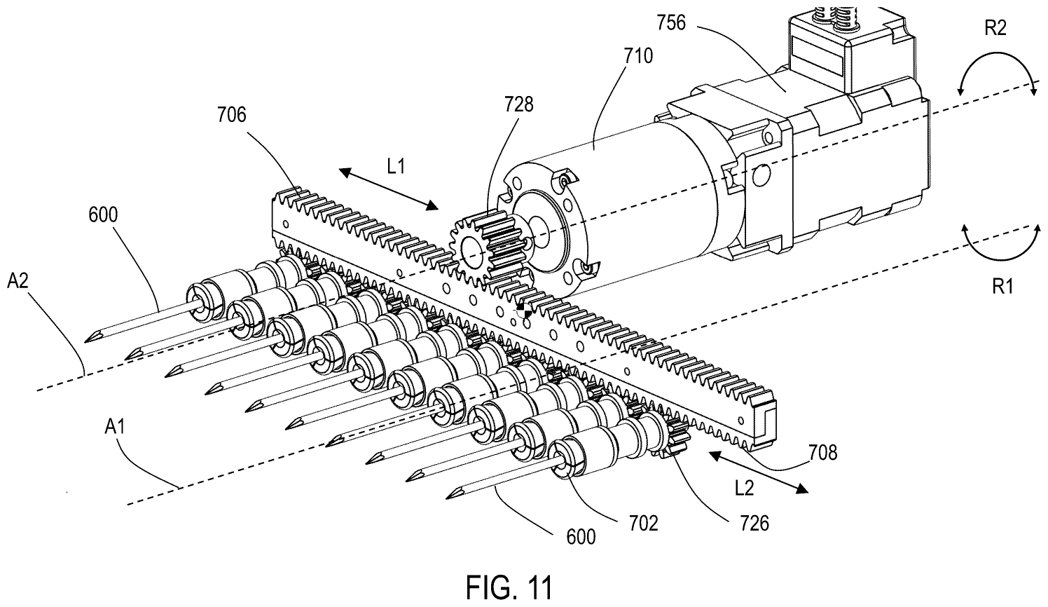

After the first facet is obtained, a second more intricate grinding process is completed by using rotary actuator 200 and linear actuator 300 working either simultaneously and/or sequentially. The rotary actuator 200 continuously rotates the workpieces around a workpiece axis A1 (FIG. 11) in a clockwise and counterclockwise direction, and the linear actuator moves the workpieces forward and backward at the same time. For example, if the actuators are working sequentially, rotary actuator 200 will first rotate the workpieces to a certain angle that allows grinding wheel to reach the surface of the workpiece, then the linear actuator will move the workpieces forward and backward along the workpiece axis A1 to give a finer precision than the first grind. While if they are working simultaneously, the rotary and linear actuators will at the same time move the workpieces in different directions. All movements and manipulations will be carefully monitored to provide the required precision of the second grind. The second grind produces the distinct shape of the Menghini needle 600 with bevel 606 having cutting edges 608 as shown in FIG. 6. Both the rotary and linear actuators work in unison to ensure precision and speed. No movement from the manipulator is required during the second grind. Although the manipulator (robot arm) may be the most powerful component and free-form of movement, allowing for heavy and congested items to be moved, it can be less precise and convenient to position workpieces during the second grind than the linear and rotary actuators, due to its inability to keep fixed at a certain speed or placement. The linear actuator is designed to move a component long a single axis and is highly precise and repeatable due to its control feedback system. Movement is usually very smooth and it can also be very quick, allowing for high speed manufacturing. The rotary actuator is designed to rotate a component in a circular motion. It is precise and repeatable, allowing for very accurate rotational movements. Thus, due to their high accuracy and ability to make precise movements, the linear and rotary actuators are better suited for fine movements than the manipulator for the second grind. Any type of Menghini needle such as a blunt-tipped Menghini needle, cutting Menghini needle, Jamshidi needle, etc. can be produced using the grinding systems and methods disclosed herein. It should be understood that the disclosure here is not limited to Menghini needles but is intended to cover all needle including surgical needles.

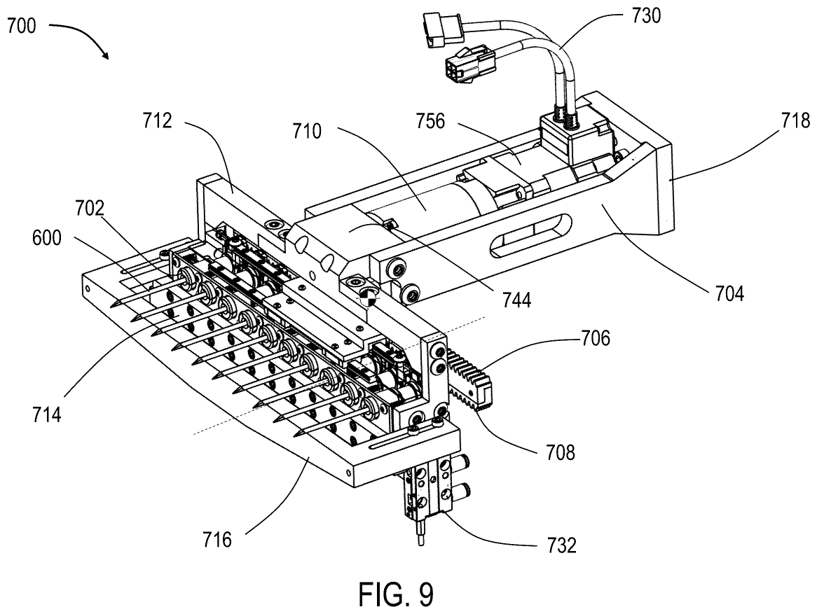

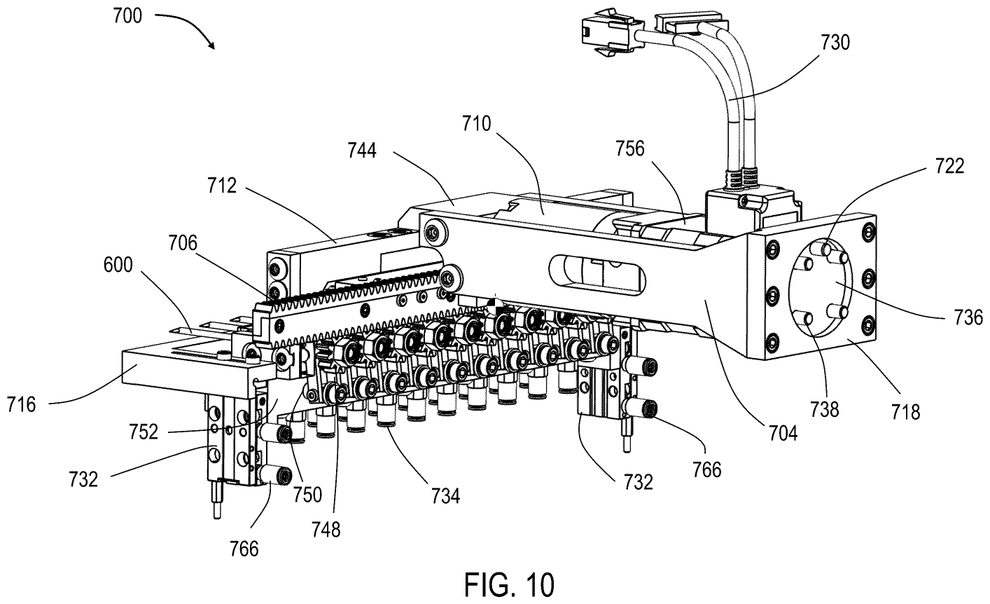

FIGS. 9-11 show details of a rotary actuator 700 according to an embodiment of the present disclosure. Rotary actuator 700 includes a frame holding a plurality of collets 702 for receiving and securing one or more workpiece 600. Collets 702 can accommodate workpieces of varying thicknesses and lengths including the Menghini needles described above. Each workpiece 600 can be loaded onto a collet 702 and firmly secured to same. A shaft 710 connects collets 702 to manipulator 400 such as a robot (not shown) via a linking structure 744 and a set of mounting arms 712. Shaft 710 is enclosed by a bracket 704 which includes an attachment end 718 for attachment to the robot. One or more connections 730 for control and/or power for the fixture are provided on shaft 710 as best shown in FIG. 9. For example, the connections 730 may control a motor 756 for driving the rotation of the shaft 710. The motor 756, which may be an electric motor such as a stepper motor or servomotor, is shown positioned within bracket 704.

Rotary actuator 700 includes a support structure 716 to minimize or eliminate deflection of workpieces 600 during a machining process such as grinding. Workpieces 600 extend past support structure 716 to allow the workpieces to contact a grinding surface (not shown). When the workpieces are pressed against the grinding surface to grind the work pieces, support structure 716 acts as a back support to minimize or eliminate deflection of workpieces during grinding.

Rotary actuator 700 includes a plurality of attachment structures 732 that allow rotary actuator 700 to be docked or attached to other structures such as machining bed or another tool. A plurality of ports 734 are provided on a base 752 to actuate pistons 750 to open and close collet 702. Attachment end 718 includes a recess 736 to receive a corresponding head (not shown) from the robot. Attachment end 718 includes a plurality of fasteners 738 and a dowel 722 configured to engage with a distal end of the robot to firmly attach rotary actuator 700 to the robot. Coolant ports (not shown) can be provided on rotary actuator 700 to allow for coolant flow to traverse around the fixture to maintain operating temperature of the fixture at desired levels.

A front perspective view of the actuator mechanism of rotary actuator 700 is shown in FIG. 11. Shaft 110 includes a shaft gear 728 coupled to a top gear rack 706. Shaft gear 728 and top gear rack form a rack and pinion arrangement wherein a rotation R2 of shaft gear 728 cause a linear translation L1 of rack 706. Rotation of shaft gear 728 is performed by rotating shaft 710 about a central shaft axis A2 as shown in FIG. 11.

Top gear rack 106 is attached to a bottom gear rack 708 such that the top and bottom gear racks move together. Linear translation L1 of top gear rack 706 causes a similar linear translation L2 of bottom gear rack 708. Each collet 702 is coupled to a collet gear 726. The collet gears are in turn coupled to the bottom gear rack 708, forming a second rack and pinion arrangement wherein linear translation L2 of bottom gear rack causes a rotation R1 about workpiece central axis A1. Therefore, rotating shaft 710 causes a rotation of each workpiece 600. The rotation of each workpiece with respect to the rotation of shaft 710 can be controlled as desired by adjusting the gear ratios. For example, increasing the rack and pinion gear ratio will provide more precision in work piece rotation, whereas decreasing the rack and pinion gear ration will provide for faster work piece rotation. Although two gear racks and two rack and pinion arrangements are shown in this embodiment, other embodiments can have only one rack and pinion arrangement to translate rotation R2 of shaft 710 to rotation R1 of each workpiece. While a linear translation mechanism with rack and pinion arrangement is used to translate rotation R2 of shaft 710 to rotation R1 of each workpiece 600 in this embodiment, other embodiments can have other gear arrangements such as herringbone gear, bevel gear, worm gear, internal gear, etc. to translate rotation R2 of shaft 710 to rotation R1 of each workpiece 600. For example, a chain or belt drive could be used to connect shaft 710 and collets 702, such as by having the shaft gear 728 and collet gears 726 be in the form of sprockets connected to a loop of roller chain. In other embodiments, a linear translation of shaft 710 can be used to rotate each workpiece 600. Pneumatic or hydraulic ports 766 allow for pneumatic or hydraulic control of support 716. For example, support 716 can be lowered to allow for loading of workpiece 600 to collet 702, and raised back to provide deflection support for the workpieces during grinding using the pneumatic or hydraulic control.

While fixture 100, 500 is generally described here in conjunction with a grinding operation, these fixtures can be used in any other machining operation to receive, secure, manipulate and release workpieces. While fixture 100, 500 is generally described here as being used with a robot, any other manipulating means from a manual to a fully automated means can be utilized in other embodiments.

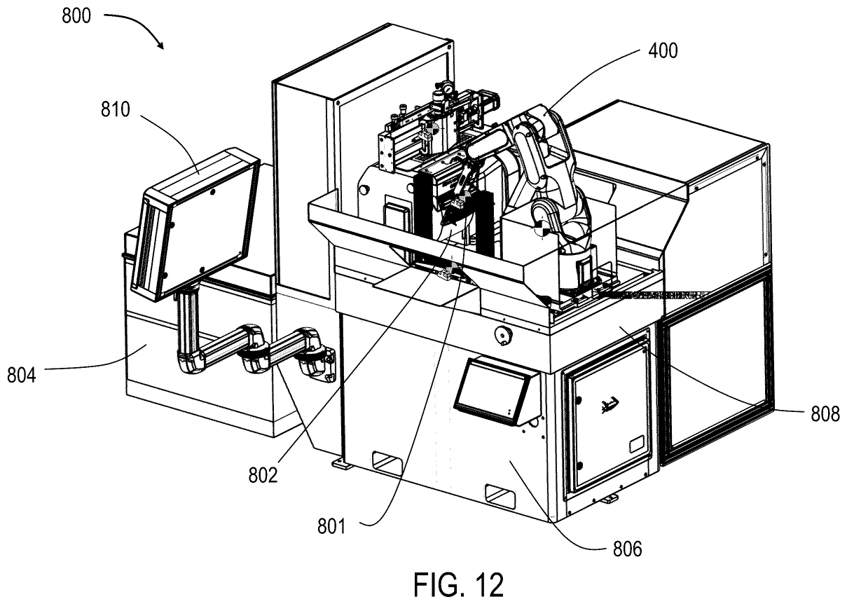

Referring to FIG. 12, there is shown a perspective view of a machining system according to another embodiment of the present disclosure. While a grinding system 800 is shown as an example in this embodiment, other machining systems such as a cutting system, welding system, drilling system, etc. can be used in other embodiments. Grinding system 800 includes a fixture 801 coupled to robot 400. Fixture 801 in this embodiment does not include a linear translator but other embodiment of the griding system disclosed herein can include fixtures 100, 500 with rotary and linear actuators. The grinding system includes a grinding wheel 802 for grinding workpieces and a coolant tank 804 which supplies coolant for the grinding operation. A machine base 806 with a machine bed 808 are also provided as shown in FIG. 12. A control panel 810 provides input for operator control and a display to monitor the grinding process. An operator can monitor and control the grinding operation through control panel 810.

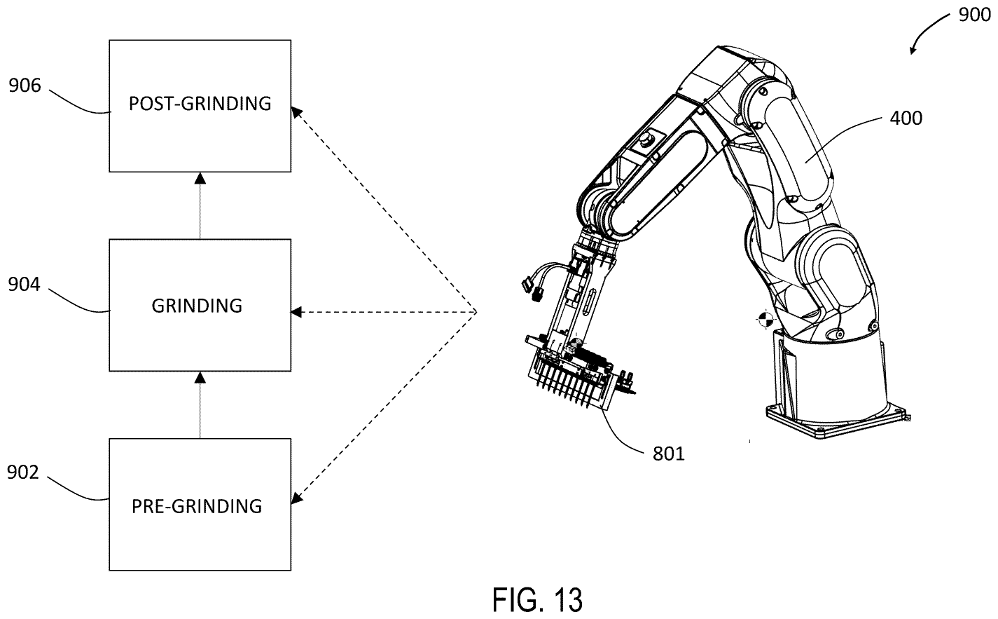

FIG. 13 shows a schematic view of a machining system 900 using fixture 801 and robot 400 according to another embodiment of the present disclosure. While machining system 900 describes a fully automated cannula manufacturing system, the machining system disclosed herein can be used for machining any other product. Cannula manufacturing system 900 represents a fully automated or semi-automated cannula manufacturing system, where all or most of the manufacturing steps are performed by robot 400 by manipulating workpieces loaded on fixture 801. Cannula manufacturing system 900 includes pre-grinding operations 902, grinding operations 904 and post-grinding operations 906. Fixture 801 can be manually pre-loaded with workpieces 600 while the fixture 801 is coupled with robot 400, or the fixture can be manually pre-loaded with workpieces 600 while the fixture 801 is disconnected from robot 400, after which the fixture 801 can be coupled to the robot 400. In another alternative, robot 400 can automatically load workpieces 600 in fixture 801 while the fixture 801 is attached to the robot 400.

With fixture 801 containing workpieces 600 coupled to robot 400, robot 400 can move the workpieces to different pre-grinding operations 902. The robot 400 can also manipulate the workpieces during any of the pre-grinding operations 902, such as by moving to change the position and orientation of the fixture 801, and/or by rotating the workpieces. Examples of pre-grinding operations include, but are not limited to, cutting workpieces to the desired lengths by electrochemical or abrasive cutting methods, pre-grinding cleaning, pre-grinding testing, etc. Robot 400 is configured to adjust the length of workpiece extending through collets by opening collets and pushing workpieces against a backstop to achieve the desired lengths.

After completing the pre-grinding operations 902, robot 400 positions and manipulates fixture 801 such that workpieces 600 are placed against a grinding surface to impart the desired cannula distal end shape as more fully explained above.

Once the cannulas are ground to the desired shape, robot 400 moves fixture 801 through one or more post-grinding operations 904. As with the pre-grinding operations, robot 400 can manipulate workpieces during each of the post-grinding operations 904, such as by moving to change the position and orientation of the fixture 801, and/or by rotating the workpieces. Examples of post-grinding operations include, but are not limited to, grit blasting, inspection (and additional grinding to fix deficiencies if necessary), electropolishing, packaging, etc.

While a Menghini needle is generally described as an example of cannula in the various embodiments of the present disclosure, the embodiments can be used for any cannula type such as, but not limited to, a trocar, a back bevel tip needle, a bias grind needle, a diamond point needle, a probe point needle, a razor edge needle, a styler, a tri-facet lancet, etc.

Furthermore, although the invention disclosed herein has been described with reference to particular features, it is to be understood that these features are merely illustrative of the principles and applications of the present invention. It is therefore to be understood that numerous modifications, including changes in the sizes of the various features described herein, may be made to the illustrative embodiments and that other arrangements may be devised without departing from the spirit and scope of the present invention. In this regard, the present invention encompasses numerous additional features in addition to those specific features set forth in the paragraphs below. Moreover, the foregoing disclosure should be taken by way of illustration rather than by way of limitation as the present invention is defined in the examples of the numbered paragraphs, which describe features in accordance with various embodiments of the invention, set forth in the claims below.

1. A fixture for holding a plurality of workpieces, the fixture comprising:
a plurality of holders coupled to a frame, each holder configured to receive and secure a workpiece, each holder being rotationally coupled to the frame;
an actuator operatively coupled to the plurality of holders to drive rotation of the holders with respect to the frame;
a linear actuator configured to linearly translate the plurality of holders; and
a coupler configured to couple the fixture to a manipulator, the manipulator configured to move the fixture;
wherein the fixture is configured to rotate a plurality of workpieces by the actuator and simultaneously linearly translate the plurality of workpieces by the linear actuator.

2. The fixture of claim 1, wherein each of the holders are coupled to a respective holder gear, and wherein the actuator includes a shaft having a shaft gear, wherein the shaft gear is operatively coupled to the holder gears to drive rotation of the holders with respect to the frame.

3. The fixture of claim 1, wherein the linear actuator includes an electric rod actuator for translating the plurality of holders.

4. The fixture of claim 3, wherein the linear actuator includes a ball spline.

5. The fixture of claim 1, further comprising an endcap fixed to a rod of the linear actuator, the endcap being configured to connect the linear actuator to the frame.

6. The fixture of claim 1, wherein the linear actuator is enclosed by a cover plate and a case.

7. The fixture of claim 1, wherein at least one of the plurality of workpiece includes a needle.

8. The fixture of claim 1, wherein the plurality of holders includes a plurality of collets, each of the plurality of collets configured to releasably secure a workpiece.

9. The fixture of claim 1, wherein the manipulator is a robot.

10. The fixture of claim 9, wherein the robot includes a robot arm having a distal end including a rotational actuator, and wherein the fixture is configured to be coupled to the distal end of the robot arm such that the actuator of the fixture is operatively coupled to the rotational actuator of the robot.

11. A grinding system comprising:
a grinding surface;
an end effector including a frame with a plurality of holders and a plurality of workpieces, each holder configured to receive and secure a workpiece, each holder being rotationally coupled to the frame;
a first actuator operatively coupled to the plurality of holders to drive rotation of the holders with respect to the frame;
a second actuator operatively coupled to the plurality of holders to linearly translate the holders; and
a coupler configured to couple the end effector to a manipulator, the manipulator configured to rotate, move, and position the end effector with respect to the grinding surface such that the workpieces contact the grinding surface to grind the workpieces in a first position of the end effector, and do not contact the grinding surface in a second position of the end effector,
wherein a rotation of the first actuator causes each of the plurality of workpieces to simultaneously rotate about each workpiece axis and a linear translation of the second actuator causes each of the plurality of workpieces to simultaneously move along each workpiece axis.

12. The grinding system of claim 11, wherein each of the holders are coupled to a respective holder gear, and wherein the first actuator includes a shaft having a shaft gear, wherein the shaft gear is operatively coupled to the holder gears to drive rotation of the holders with respect to the frame.

13. The grinding system of claim 11, wherein the second actuator includes an electric rod actuator for translating the plurality of holders.

14. The grinding system of claim 13, wherein the second actuator includes a ball spline.

15. The grinding system of claim 11, further comprising an endcap fixed to a rod of the second actuator, the endcap being configured to connect the second actuator to the frame.

16. The grinding system of claim 11, wherein the second actuator is enclosed by a cover plate and a case.

17. The grinding system of claim 11, wherein the workpiece includes a needle.

18. The grinding system of claim 11, wherein the plurality of holders includes a plurality of collets, each of the plurality of collets configured to releasably secure a workpiece.

19. The grinding system of claim 11, wherein the manipulator is a robot.

20. The grinding system of claim 19, wherein the robot includes a robot arm having a distal end including a rotational actuator, and wherein the second actuator is configured to be coupled to the distal end of the arm such that the second actuator is operatively coupled to the rotational actuator of the robot.
